(19) United States
(12) Patent Application Publication
(10) Pub. No.: US 2008/0069244 A1
(43) Pub. Date: Mar. 20, 2008

(54) Information processing apparatus, decoder, and operation control method of playback apparatus

(75) Inventor: Katsuhisa Yano, Hachioji-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/898,160

(22) Filed: Sep. 10, 2007

(30) Foreign Application Priority Data
Sep. 15, 2006 (JP) 2006-251607

(51) Int. Cl. H04N 7/12

(52) U.S. Cl. 375/240.24

(57) ABSTRACT

According to one embodiment, an information processing apparatus includes an input unit configured to input a moving picture stream encoded for respective macroblocks of n×n pixels, which are generated by dividing each image in a matrix pattern, an analysis unit configured to analyze information of a slice which is included in the moving picture stream input by the input unit and is configured by at least one macroblock row obtained by arranging macroblocks in a row direction, and to acquire type information of each macroblock, at least two decoding processing unit configured to execute decoding processes for respective macroblocks, and an control unit configured to divide the macroblock row which configures the slice based on the type information of each macroblock acquired by the analysis unit, and to control the at least two decoding processing unit to execute in parallel decoding processes of the macroblock row.

### CROSS-REFERENCE TO RELATED APPLICATIONS

This application is based upon and claims the benefit of priority from Japanese Patent Application No. 2006-251607, filed Sep. 15, 2006, the entire contents of which are incorporated herein by reference.

### BACKGROUND

1. Field

One embodiment of the invention relates to a decoding technique of a moving picture stream suitably applied to an information processing apparatus such as a personal computer or the like.

2. Description of the Related Art

In recent years, a personal computer having an AV function equivalent to audio video (AV) devices such as a DVD (Digital Versatile Disc) player, television device, and the like begins to prevail. A personal computer of this type uses a software decoder which decodes an encoded moving picture stream by software. Using the software decoder, a CPU can decode an encoded moving picture stream without adding dedicated hardware.

Recently, the H.264/Advanced Video Coding (AVC) standard has received a lot of attention as the next generation moving picture encoding technique. This H.264/AVC standard provides an encoding technique achieving higher efficiency than is possible with conventional MPEG2 and MPEG4 encoding. For this reason, the encoding and decoding processes compliant with the H.264/AVC standard require processing volumes larger than MPEG2 and MPEG4.

Therefore, the personal computer which is designed to decode a moving picture stream encoded according to the H.264/AVC standard by software is required to attain high efficiency, e.g., parallel execution of a plurality of processes as much as possible. Hence, various proposals for parallel execution of the decoding processes of a moving picture stream have been made (e.g., see Jpn. Pat. Appln. KOKAI Publication No. 2006 129285 (KOKAI) and the like).

In a decoding apparatus of this Jpn. Pat. Appln. KOKAI Publication No. 2006 129285 (KOKAI), the signal processing according to the H.264/AVC standard comprises a mechanism called a macroblock processing agent which manages the processing states of respective macroblocks in consideration of the dependence among upper left, upper, upper right, and left surrounding macroblocks. That is, macroblock processing is executed (in parallel if it is possible) while scanning the processible state.

However, this method requires complicated procedures, and may increase a system load. Hence, a mechanism that allows parallel execution of decoding processes of a moving picture stream by simpler procedures is strongly demanded.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the outer appearance of a computer according to one embodiment of the invention;

FIG. 2 is an exemplary block diagram showing the system arrangement of the computer according to the embodiment;

FIG. 3 is an exemplary functional block diagram of a decoder function of a video playback application program used in the computer according to the embodiment;

FIG. 4 is an exemplary diagram for explaining the decoding process to be executed by the video playback application program according to the embodiment;

FIG. 5 shows the exemplary configuration of a moving picture stream encoded by an encoding method defined by the H.264/AVC standard;

FIG. 6 is an exemplary view for explaining the division principle of a macroblock group by the video playback application program according to the embodiment; and

FIG. 7 is an exemplary flowchart showing the sequence of the decoding process to be executed by the video playback application program according to the embodiment.

### DETAILED DESCRIPTION

Various embodiments according to the invention will be described hereinafter with reference to the accompanying drawings. In general, according to one embodiment of the invention, an information processing apparatus includes an input unit configured to input a moving picture stream encoded for respective macroblocks of n×n pixels, which are generated by dividing each image in a matrix pattern, an analysis unit configured to analyze information of a slice which is included in the moving picture stream input by the input unit and is configured by at least one macroblock row obtained by arranging macroblocks in a row direction, and to acquire type information of each macroblock, at least two decoding processing unit configured to execute decoding processes for respective macroblocks, and an control unit configured to divide the macroblock row which configures the slice based on the type information of each macroblock acquired by the analysis unit, and to control the at least two decoding processing unit to execute in parallel decoding processes of the macroblock row.

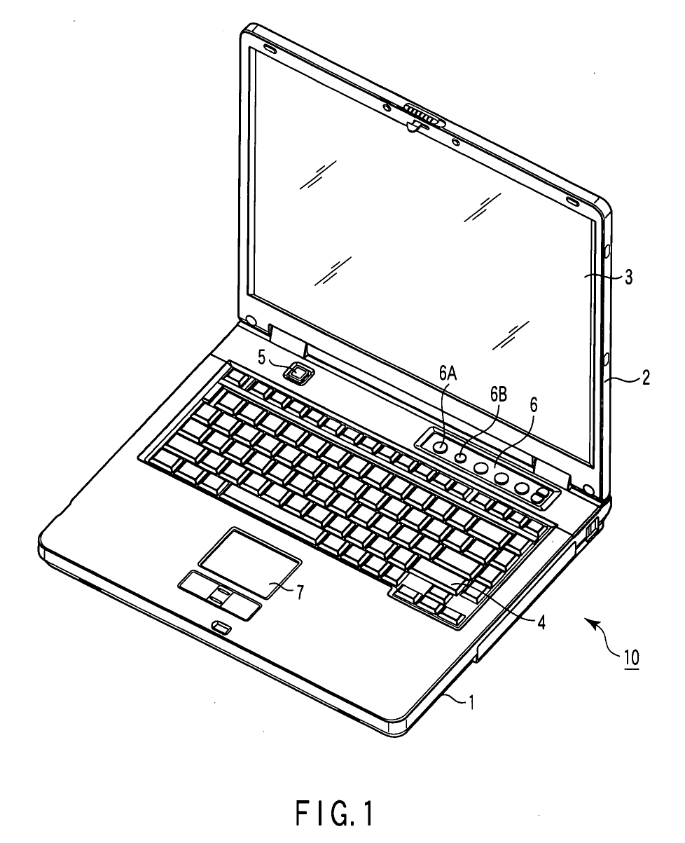

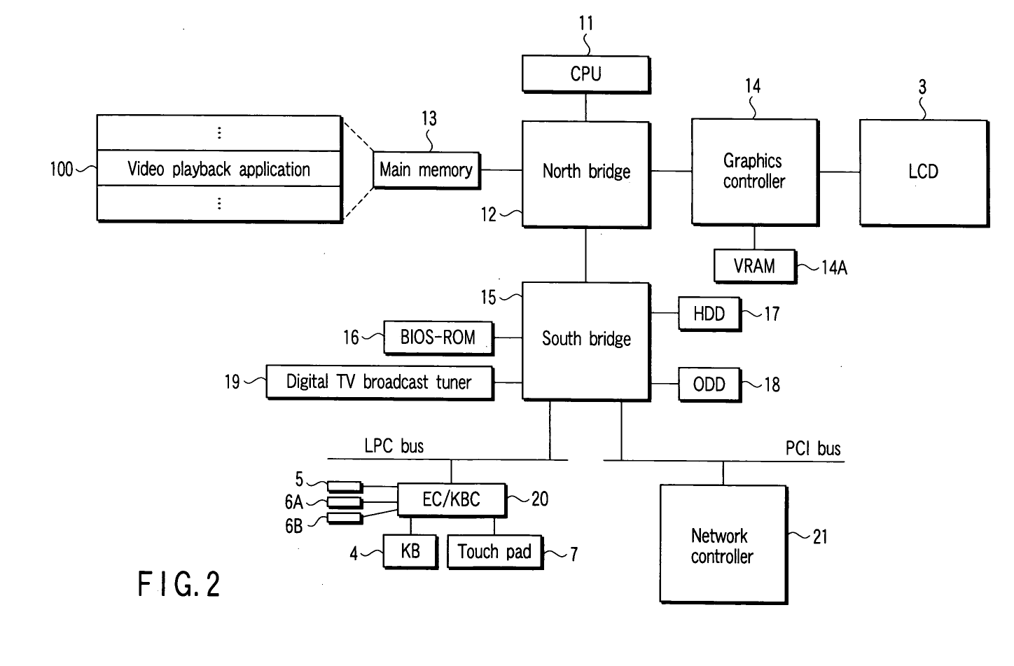

The arrangement of an information processing apparatus according to one embodiment of the invention will be described below with reference to FIGS. 1 and 2. This information processing apparatus is implemented as, for example, a notebook type personal computer 10.

FIG. 1 is an exemplary perspective view showing the open state of a display unit of the notebook type personal computer 10. This computer 10 comprises a computer main body 1 and display unit 2. In the display unit 2, a display device comprising an LCD (Liquid Crystal Display) 3 is built in, and the display screen of the LCD 3 is located nearly the center of the display unit 2.

The display unit 2 is attached to the computer main body 1 to be pivotal between the open position and close position. The computer main body 1 has a low-profile, box-shape housing, and a keyboard 4, a power button 5 used to turn on/off this computer 10, an input operation panel 6, a touch pad 7, and the like are arranged on its upper surface.

The input operation panel 6 is an input device used to input an event corresponding to a pressed button to the system, and comprises a plurality of buttons used to respectively activate a plurality of functions. These buttons include a TV activate button 6A and Digital Versatile Disc (DVD) activate button 6B. The TV activate button 6A is pressed to activate a TV function of playing back and recording broadcast program data such as a digital TV broadcast program. When the user presses this TV activate button 6A, a TV application program used to execute this TV function is launched. The DVD activate button 6B is used to play back video content recorded on a DVD. When the user presses this DVD activate button 6B, an application program for playing back the video content is automatically launched.

The system arrangement of the computer 10 will be described below with reference to FIG. 2.

As shown in FIG. 2, the computer 10 comprises a CPU 11, north bridge 12, main memory 13, graphics controller 14, south bridge 15, BIOS-ROM 16, hard disc drive (HDD) 17, optical disc drive (ODD) 18, digital TV broadcast tuner 19, embedded controller/keyboard controller IC (EC/KBC) 20, network controller 21, and the like.

The CPU 11 is a processor provided to control the operation of the computer 10, and executes an operating system (OS) and various application programs such as a video playback application program 100 and the like, which are loaded from the HDD 17 onto the main memory 13.

The video playback application program 100 is software used to decode and playback encoded moving picture data. This video playback application program 100 is a software decoder compliant with the H.264/AVC standard. The video playback application program 100 has a function of decoding a moving picture stream (for example, a digital TV broadcast program received by the digital TV broadcast tuner 19, high-definition (HD) video content read from the ODD 18, or the like) encoded by an encoding method defined by the H.264/AVC standard.

The CPU 11 also executes a basic input/output system (BIOS) stored in the BIOS-ROM 16. The BIOS is a program for hardware control.

The north bridge 12 is a bridge device that connects the local bus of the CPU 11 and the south bridge 15. The north bridge 12 incorporates a memory controller used to make access control of the main memory 13. The north bridge 12 also has a function of executing communications with the graphics controller 14 via an Accelerated Graphics Port (AGP) bus or the like.

The graphics controller 14 is a display controller which controls the LCD 3 used as a display monitor of this computer 10. The graphics controller 14 generates a display signal to be output to the LCD 3 based on image data written in a video memory (VRAM) 14A.

The south bridge 15 controls respective devices on a Low Pin Count (LPC) bus and those on a Peripheral Component Interconnect (PCI) bus. The south bridge 15 incorporates an Integrated Drive Electronics (IDE) controller used to control the HDD 17. Furthermore, the south bridge 15 also has a function of controlling the digital TV broadcast tuner 19 and a function of making access control of the BIOS-ROM 16.

The HDD 17 is a storage device which stores various kinds of software and data. The optical disc drive (ODD) 18 is a drive unit used to drive storage media such as a DVD and the like which hold video content. The digital TV broadcast tuner 19 is a receiver which externally receives broadcast program data of a digital TV broadcast program and the like.

The EC/KBC 20 is a single-chip microcomputer on which an embedded controller for power management and a keyboard controller used to control the keyboard (KB) 4 and touch pad 7 are integrated. The EC/KBC 20 has a function of turning on/off the power supply of the computer 10 upon operation of the power button 5 by the user. Furthermore, the EC/KBC 20 can turn on the power supply of this computer 10 upon operation of the TV activate button 6A or DVD activate button 6B by the user. The network controller 21 is a communication device which executes communications with an external network such as the Internet or the like.

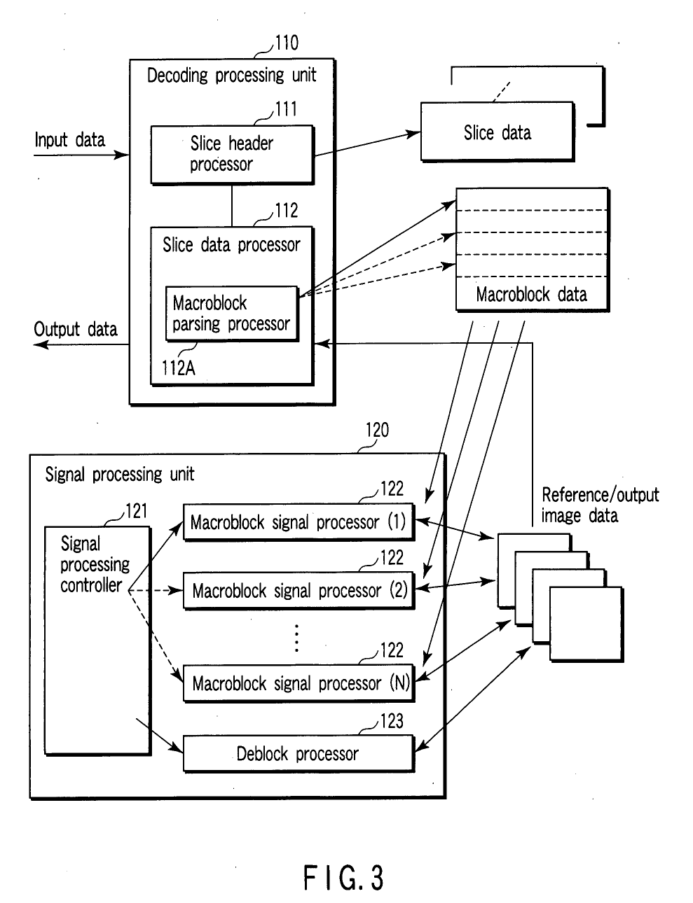

FIG. 3 is an exemplary functional block diagram of the decoder function of the video playback application program 100 which runs on the computer 10 with the above arrangement.

As shown in FIG. 3, the video playback application program 100 comprises a decoding processing unit 110 and a signal processing unit 120.

A slice header processor 111 in the decoding processing unit 110 analyzes a slice header of a digital TV broadcast program received by the digital TV broadcast tuner 19 or HD video content read from the ODD 18 (a moving picture stream encoded by the encoding method defined by the H.264/AVC standard), and divides the moving picture stream into macroblock rows obtained by arranging macroblocks in a row direction. In the H.264/AVC standard, each frame is encoded by for respective macroblocks each having 16×16 pixels, and a slice is configured by one or more macroblock rows (normally, the slice is configured by macroblock rows for one frame). The slice has a header part (slice header) and data part (slice data).

A slice data processor 112 of the decoding processing unit 110 analyzes the slice data, and divides the slice data into individual macroblocks. A macroblock parsing processor 112A in the slice data processor 112 parses each macroblock to obtain quantized DCT coefficients, mode information indicating one of an intra-frame encoding mode (intra encoding mode) and motion-compensated inter-frame predictive encoding mode (inter encoding mode) used to encode the macroblock of interest, motion vector information used in inter encoding, and intra-frame prediction information used in intra encoding.

The data divided into macroblocks by the decoding processing unit 110 undergo a decoding process by the signal processing unit 120. A signal processing controller 121 controls the overall signal processing unit 120, and a plurality of macroblock signal processors 122 execute decoding processes for respective macroblocks. A deblock processor 123 executes deblocking filter processing for reducing block distortions to respective macroblocks decoded by the macroblock signal processors 122. The decoder function of the video playback application program 100 comprises the plurality of macroblock signal processors 122 in the signal processing unit 120, and allows parallel execution of the decoding processes of macroblock rows in slice data under simple control of the signal processing controller 121. This point will be described in detail below.

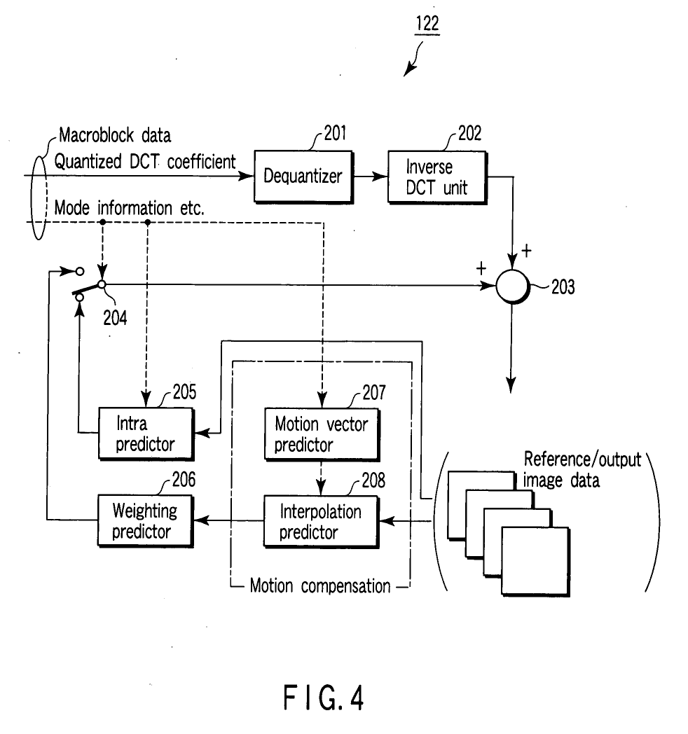

The decoding process to be executed by each of the plurality of macroblock signal processors 122 will be described below with reference to FIG. 4.

The macroblock signal processor 122 is compliant with the H.264/AVC standard, and comprises a dequantizer 201, inverse discrete cosine transform (DCT) unit 202, adder 203, mode select switch unit 204, intra predictor 205, weighting predictor 206, motion vector predictor 207, and interpolation predictor 208. The orthogonal transform of H.264 is an integer prediction and is different from the conventional DCT, but it will be called DCT in this embodiment.

The quantized DCT coefficients, mode information, motion vector information, and intra-frame prediction information obtained by parsing of the macroblock parsing processor 112A of the slice data processor 112 are respectively sent to the dequantizer 201, mode select switch unit 204, motion vector predictor 207, and intra predictor 205.

The 16×16 quantized DCT coefficients of each macroblock are transformed into 16×16 DCT coefficients (orthogonal transform coefficients) by dequantization processing of the dequantizer 201. These 16×16 DCT coefficients are transformed from frequency information into 16×16 pixel values by inverse integer DCT (inverse orthogonal transform) processing by the inverse DCT unit 202. These 16×16 pixel values are a prediction error signal corresponding to a macroblock. The prediction error signal is sent to the adder 203, and is added to a prediction signal (motion-compensated inter-frame prediction signal or intra-frame prediction signal) corresponding to that macroblock, thus decoding the 16×16 pixel values corresponding to the macroblock.

In the intra encoding mode, a prediction signal is generated from each frame to be encoded, and is encoded by orthogonal transformation (DCT), quantization, and entropy encoding. Hence, the mode select switch unit 204 selects the intra predictor 205, thus adding an intra-frame prediction signal from the intra predictor 205 to the prediction error signal.

On the other hand, in the inter encoding mode, a motion-compensated inter-frame prediction signal corresponding to a frame to be encoded is generated in a predetermined shape unit by estimating a motion from the already encoded frame, and a prediction error signal obtained by subtracting the motion-compensated inter-frame prediction signal from each frame to be encoded is encoded by orthogonal transformation (DCT), quantization, and entropy encoding. Hence, the mode select switch unit 204 selects the weighting predictor 206, thus adding the motion-compensated inter-frame prediction signal obtained by the motion vector predictor 207, interpolation predictor 208, and weighting predictor 206 to the prediction error signal.

The intra predictor 205 generates an intra-frame prediction signal of a block to be decoded included in a frame to be decoded from that frame. The intra predictor 205 executes intra-frame prediction processing according to the aforementioned intra-frame prediction information, thus generating an intra-frame prediction signals from pixel values in another already decoded block which neighbors the block to be decoded and exists in the same frame as the block to be decoded. The intra prediction is a technique for enhancing the compression ratio by exploiting the pixel correlation between blocks.

On the other hand, the motion vector predictor 207 generates motion vector information based on motion vector difference information corresponding to a block to be decoded. The interpolation predictor 208 generates a motion-compensated inter-frame prediction signal from a pixel group with an integer precision and a prediction interpolation pixel group with a ¼ pixel precision within a reference frame based on the motion vector information corresponding to the block to be decoded. The weighting predictor 206 executes processing for multiplying the motion-compensated inter-frame prediction signal by a weighting coefficient for each motion-compensated block, thus generating a weighted motion-compensated inter-frame prediction signal. The weighting prediction is processing for predicting the brightness of a frame to be decoded. With this weighting prediction processing, the image quality of an image whose brightness changes with time like a fade-in or fade-out image can be improved.

In this way, each macroblock signal processor 122 executes processing for decoding the frame to be decoded by adding the prediction signal (motion-compensated inter-frame prediction signal or intra-frame prediction signal) to the prediction error signal corresponding to the frame to be decoded for each macroblock.

Data decoded by the respective macroblock signal processors 122 are held for a predetermined period so as to be used to decode another block, and are output after they undergo the deblocking filter processing by the deblock processor 123.

As described above, the decoding process of a macroblock encoded in the intra encoding mode uses an intra-frame prediction signal. On the other hand, the decoding process of a macroblock encoded in the inter encoding mode uses a motion-compensated inter-frame prediction signal. That is, a macroblock in the intra encoding mode has dependence with surrounding macroblocks (in an identical frame), but a macroblock in the inter encoding mode does not have any dependence with surrounding macroblocks. Hence, first, the signal processing controller 121 of the signal processing unit 120 divides a macroblock row configured by a plurality of macroblocks by dividing it immediately before a macroblock of the inter encoding mode, based on the mode information obtained by analysis of the slice data processor 112 of the decoding processing unit 110. In the signal processing according to the H.264/AVC standard, a given macroblock has dependence with upper left, upper, upper right, and left (forward in the processing order) surrounding macroblocks in some cases (in the case of a macroblock of the intra encoding mode). However, as for division for parallel processes in one macroblock row, only the left macroblock need only be considered.

Second, the signal processing controller 121 of the signal processing unit 120 delays, for two macroblock rows in consideration of the presence of dependence with the upper left, upper, and upper right surrounding macroblocks, execution of the deblocking filter processing by the deblock processor 123 for the macroblock decoded by the macroblock signal processor 122. That is, upon completion of the macroblock decoding processes for a given macroblock row, execution of the deblocking filter processing of macroblocks in a macroblock row above the current row by two rows starts. By delaying for two macroblock rows, a macroblock of the intra encoding mode can be decoded with reference to upper left, upper, and upper right surrounding macroblocks before application of the deblocking filter processing (in an original state).

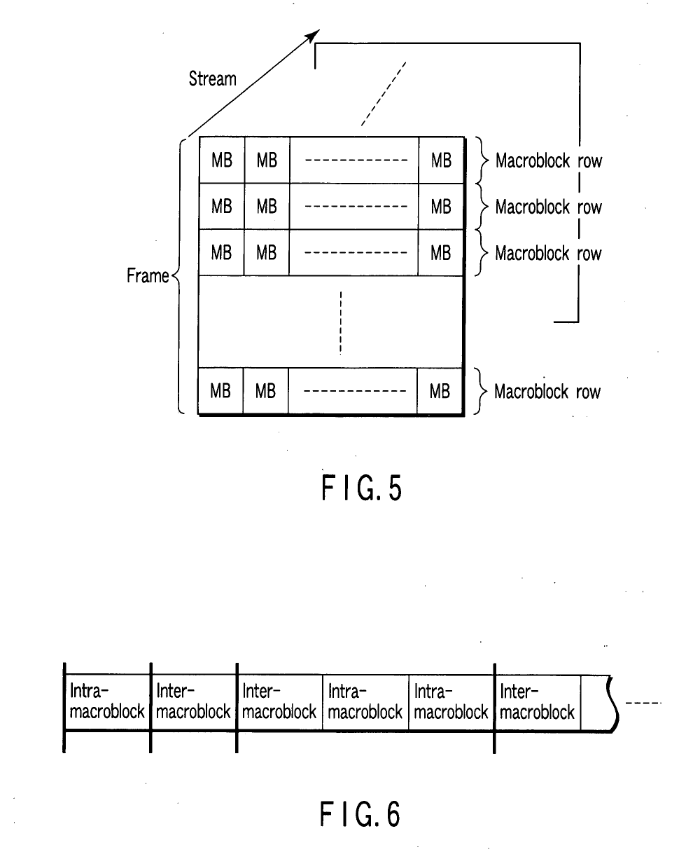

FIG. 5 shows the exemplary configuration of a moving picture stream encoded by the encoding method defined by the H.264/AVC standard. As shown in FIG. 5, each frame is encoded for respective macroblocks of 16×16 pixels, which are divisionally generated in a matrix pattern. Upon decoding the moving picture stream encoded in this way, the signal processing controller 121 of the signal processing unit 120 divides a macroblock row in which macroblocks are arranged in the row direction by dividing it immediately before each macroblock of the inter encoding mode (inter-macroblock), as shown in FIG. 6. The signal processing controller 121 controls the plurality of macroblock signal processors 122 to execute in parallel the decoding process of macroblocks of the macroblock row after division. That is, the signal processing controller 121 implements division for the parallel processes in each macroblock row under the simple control that refers to the mode information used to determine whether or not a macroblock of interest is encoded in the inter encoding mode.

The signal processing controller 121 controls the macroblock signal processors 122 to start execution of the deblocking filter processing of macroblocks of a macroblock row above a certain macroblock row by two rows at the completion timing of the decoding processes of macroblocks of that macroblock row. Upon completion of the decoding processes of macroblocks of a macroblock row at the terminal end of slice data (a lowermost macroblock row in FIG. 5 when slice data is configured by macroblock rows for one frame), the signal processing controller 121 controls the macroblock signal processors 122 to start execution of the deblocking filter processing of macroblocks of a macroblock row immediately above the last macroblock row and that of the deblocking filter processing of macroblocks of the last macroblock row. This is because there are no macroblocks of the intra encoding mode to be decoded with reference to these macroblocks.

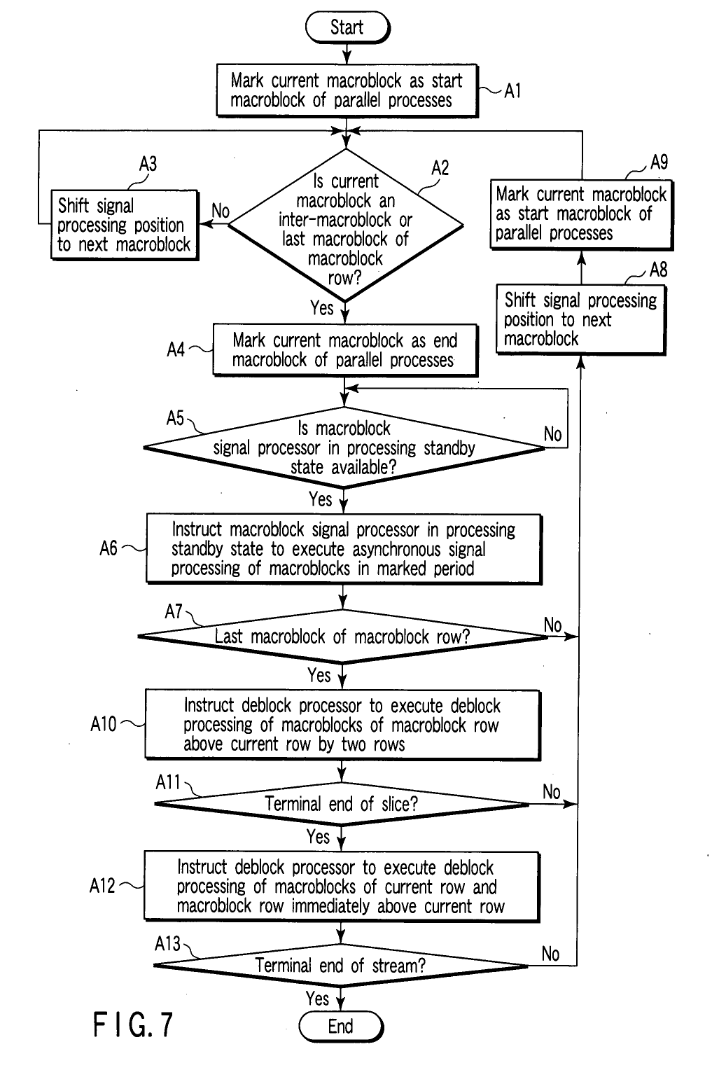

The decoding process sequence executed by the signal processing unit 120 of the video playback application program 100 will be described below with reference to the flowchart of FIG. 7.

The signal processing controller 121 advances the process to define the leftmost macroblock in each macroblock row, and marks the current macroblock as a start macroblock of parallel processes (block A1). The signal processing controller 121 checks if the current macroblock corresponds to a macroblock of the inter encoding mode or the last macroblock of the macroblock row (block A2). If the current macroblock corresponds to neither of these macroblocks (NO in block A2), the signal processing controller 121 shifts the signal processing position to the next macroblock (block A3) to repeat the process in block A2.

On the other hand, if the current macroblock corresponds to a macroblock of the inter encoding mode or the last macroblock of the macroblock row (YES in block A2), the signal processing controller 121 marks the current macroblock as an end macroblock of the parallel processes (block A4). The signal processing controller 121 checks if a macroblock signal processor 122 in a standby state is available (block A5). If such macroblock signal processor 122 is available (YES in block A5), the signal processing controller 121 instructs this macroblock signal processor 122 in the standby state to decode the macroblocks in the marked period (asynchronous processing) (block A6).

The signal processing controller 121 checks if the macroblock corresponding to the decoding instruction to the macroblock signal processor 122 is the last macroblock of the macroblock row (block A7). If that macroblock is not the last macroblock (NO in block A7), the signal processing controller 121 shifts the signal processing position to the next macroblock (block A8) and marks the current macroblock as a start macroblock of the parallel processes (block A9), thus repeating the processes from block A2.

If that macroblock is the last macroblock of the macroblock row (YES in block A7), the signal processing controller 121 instructs the deblock processor 123 to execute the deblock processing of macroblocks in a macroblock row above the current row by two rows (block A10). The signal processing controller 121 checks if this macroblock row is the terminal end of slice data (block A11). If that macroblock row is not the terminal end of slice data (NO in block A11), the signal processing controller 121 shifts the signal processing position to the next macroblock (block A8) and marks the current macroblock as a start macroblock of the parallel processes (block A9), thus repeating the processes from block A2.

On the other hand, if that macroblock is the terminal end of slice data (YES in block A11), the signal processing controller 121 instructs the deblock processor 123 to execute the deblock processing of macroblocks in the current macroblock row and a macroblock row immediately above the current macroblock row (block A12). The signal processing controller 121 checks if this slice data is the terminal end of a stream (block A13). If that slide data is not the terminal end of a stream (NO in block A13), the signal processing controller 121 shifts the signal processing position to the next macroblock (block A8) and marks the current macroblock as a start macroblock of the parallel processes (block A9), thus repeating the processes from block A2. If that slice data is the terminal end of a stream (YES in block A13), the signal processing controller 121 ends this processing.

As described above, according to this embodiment, the decoding processes of a moving picture stream can be executed in parallel based only on the type information of each macroblock obtained by analyzing slice data included in the moving picture stream.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
an input unit configured to input a moving picture stream encoded for respective macroblocks of n×n pixels, which are generated by dividing each image in a matrix pattern;
an analysis unit configured to analyze information of a slice which is included in the moving picture stream input by the input unit and is configured by at least one macroblock row obtained by arranging macroblocks in a row direction, and to acquire type information of each macroblock;
at least two decoding processing unit configured to execute decoding processes for respective macroblocks; and
an control unit configured to divide the macroblock row which configures the slice based on the type information of each macroblock acquired by the analysis unit, and to control the at least two decoding processing unit to execute in parallel decoding processes of the macroblock row.

2. The information processing apparatus according to claim 1, wherein the control unit divides the macroblock row by dividing the macroblock row immediately before an inter-macroblock encoded in a motion-compensated inter-frame prediction encoding mode.

3. The information processing apparatus according to claim 1, further comprising a deblock processing unit configured to execute deblocking filter processing for reducing block distortions to the macroblocks decoded by each decoding processing unit, and
the control unit controls the deblock processing unit to execute the deblocking filter processing of the macroblocks by delaying the deblocking filter processing for two macroblock rows after the decoding process of each decoding processing unit.

4. The apparatus according to claim 3, wherein the control unit controls the deblock processing unit to execute the deblocking filter processing of macroblocks of a macroblock row immediately above the last macroblock row and that last macroblock row, when the decoding processing unit completes the decoding process of the macroblocks of a last macroblock row of each slice.

5. A decoder comprising:
a determination unit configured to analyze slice data of a moving picture stream according to the H.264/AVC standard and to determine whether or not each macroblock is an inter-macroblock;
at least two decoding processing unit; and
a control unit configured to divide a macroblock row in slice data by dividing the macroblock row immediately before the macroblock which is determined as the inter-macroblock by the determination unit, and to control the at least two decoding processing unit to execute in parallel decoding processes of the macroblock row.

6. The decoder according to claim 5, further comprising a deblock processing unit, and
the control unit controls the deblock processing unit to execute deblocking filter processing of macroblocks by delaying the deblocking filter processing for two macroblock rows after the decoding process of each decoding processing unit.

7. The decoder according to claim 6, wherein the control unit controls the deblock processing unit to execute the deblocking filter processing of macroblocks of a macroblock row immediately above the last macroblock row and that last macroblock row, when the decoding processing unit completes the decoding process of the macroblocks of a last macroblock row of each slice.

8. An operation control method of a playback apparatus which decodes a moving picture stream encoded for respective macroblocks of n×n pixels, which are generated by dividing each image in a matrix pattern, the method comprising:
analyzing information of a slice which is included in an input moving picture stream and is configured by at least one macroblock row obtained by arranging macroblocks in a row direction, and acquiring type information of each macroblock; and
dividing the macroblock row which configures the slice based on the acquired type information of each macroblock, and executing in parallel decoding processes of the macroblock row.

9. The operation control method according to claim 8, wherein the dividing the macroblock row includes dividing the macroblock row by dividing the macroblock row immediately before an inter-macroblock encoded in a motion-compensated inter-frame prediction encoding mode.

10. The operation control method according to claim 8, wherein the executing in parallel decoding processes of the macroblock row includes executing the deblocking filter processing of the macroblocks by delaying the deblocking filter processing for two macroblock rows after the decoding process of each decoding processing unit.

11. The operation control method according to claim 10, wherein executing the deblocking filter processing of the macroblocks includes deblocking filter processing of macroblocks of a macroblock immediately above the last macroblock row and that last macroblock row starts, when the decoding process of macroblocks of a last macroblock row of each slice is completed.
